(19) United States
(12) Patent Application Publication
(10) Pub. No.: US 2003/0224679 A1
(43) Pub. Date: Dec. 4, 2003

(54) Fire resistant structural material and fabrics made therefrom

(76) Inventor: Younger Ahluwalia, Desoto, TX (US)

Correspondence Address: BAKER & BOTTS, 30 ROCKEFELLER PLAZA, NEW YORK, NY, 10112

(21) Appl. No.: 10/354,216

(22) Filed: Jan. 29, 2003

Related U.S. Application Data
(63) Continuation-in-part of application No. 09/663,255, filed on Sep. 15, 2000, now Pat. No. 6,586,353.
(63) Continuation-in-part of application No. 09/955,395, filed on Sep. 18, 2001.
(60) Provisional application No. 60/168,057, filed on Nov. 30, 1999.
(60) Provisional application No. 60/352,691, filed on Jan. 29, 2002.
(60) Provisional application No. 60/352,692, filed on Jan. 29, 2002.
(60) Provisional application No. 60/352,693, filed on Jan. 29, 2002.

(51) Int. Cl. B32B 5/16; B32B 27/20; B32B 5/02; B32B 27/04; B32B 27/12; B32B 5/18; B32B 5/24; B32B 5/26

(52) U.S. Cl. 442/72; 442/101; 442/123; 442/136; 442/381; 442/370

(57) ABSTRACT

The present invention relates to a fire resistant structural material comprising a surfactant component, surfactant-generated microcells, a filler component and a binder component. In addition, the present invention relates to fire resistant fabric materials comprising a substrate coated with a coating comprising the fire resistant structural material. Further, the present invention relates to fire resistant articles of manufacture comprising the fire resistant structural and/or fabric materials, and particularly to mattresses comprising the fire resistant fabric material.

### CROSS REFERENCE TO RELATED APPLICATIONS

This application is a continuation-in-part of pending U.S. application Ser. No. 09/663,255 filed on Sep. 15, 2000, which claims priority under 35 U.S.C. §119(e) to Provisional Application No. 60/168,057, filed Nov. 30, 1999; and this application is also a continuation-in-part of pending U.S. application Ser. No. 09/955,395 filed on Sep. 18, 2001; and this application also claims priority under 35 U.S.C. §119(e) to Provisional Application Nos. 60/352,691, 60/352,692, and 60/352,693, which were all filed on Jan. 29, 2002.

### FIELD OF THE INVENTION

This invention relates to fire resistant structural materials and to fire resistant fabric materials made therefore, and more particularly to such materials which may be adhered to decorative fabrics to provide fire resistant decorative fabrics especially suitable for use in mattresses, draperies, furniture upholstery, and the like. The invention further relates to articles of manufacture, e.g. mattresses, comprising the fire resistant fabric materials.

### BACKGROUND OF THE INVENTION

Various attempts have been made to produce fire resistant fabrics having characteristics that make them suitable for use in mattresses and in other applications, e.g., draperies and upholstery.

U.S. Pat. No. 5,540,980 is directed to a fire resistant fabric useful for mattress ticking. The fabric is formed from a corespun yarn comprising a high temperature resistant continuous filament fiberglass core and a low temperature resistant staple fiber sheath which surrounds the core. The fiberglass core comprises about 20% to 40% of the total weight of the corespun yarn while the sheath comprises about 80% to about 60% of the total weight of the corespun yarn. The corespun yarn can be woven or knit to form fabric with fire resistant characteristics. When exposed to a flame, the sheath chars and the fiberglass core serves as a fire barrier. In a preferred embodiment, the sheath is made from cotton.

U.S. Pat. No. 5,091,243 discloses a fire barrier fabric comprising a substrate formed of corespun yarns and a coating carried by one surface of the substrate. Other fire resistant fabrics include Fenix™ (Milliken, LaGrange, Ga.) and fabrics made by Freudenberg (Lowell, Mass.), Ventex Inc. (Great Falls, Va.), BASF, Basofil Fiber Division (Enka, N.C.), Carpenter Co. (Richmond, Va.), Legget and Platt (Nashville, Tenn.), Chiquala Industries Products Group (Kingspoint, Tenn.), and Sandel (Amsterdam, N.Y.). DuPont also manufacturers a fabric made from Kevlar™ thread. In addition, the mattress industry has attempted to manufacture mattresses by using Kevlar™ thread, glass thread, flame retardant polyurethane foams, flame retardant ticking, flame retardant cotton cushioning and flame retardant tape. However, use of these materials adds to the cost of mattresses and may result in a cost-prohibitive product. Additionally, some fire-resistant threads, such as glass threads, are difficult to work with and can break, adding to the time required for manufacturing the mattress, which also translates into added costs.

Flame retardant tapes are also difficult to work with and increase production time. In addition, flame retardant tapes are only available in a limited number of colors and sizes. Flame retardant polyurethanes may release noxious gases when they smolder and ignite. Furthermore, the process for flame retarding ticking often compromises the desired characteristics of the ticking (e.g. it may no longer be soft, drapable, pliable, flexible, etc).

For many years substrates such as fiberglass have been coated with various compositions to produce materials having utility in, among other applications, the building industry. U.S. Pat. No. 5,001,005 relates to structural laminates made with facing sheets. The laminates described in that patent include thermosetting plastic foam and have planar facing sheets comprising 60% to 90% by weight glass fibers (exclusive of glass micro-fibers), 10% to 40% by weight non-glass filler material and 1% to 30% by weight non-asphaltic binder material. The filler materials are indicated as being clay, mica, talc, limestone (calcium carbonate), gypsum (calcium sulfate), aluminum trihydrate (ATH), antimony trioxide, cellulose fibers, plastic polymer fibers or a combination of any two or more of those substances. The patent further notes that the filler materials are bonded to the glass fibers using binders such as urea-, phenol- or melamine-formaldehyde resins (UF, PF, and MF resins), or a modified acrylic or polyester resin. Ordinary polymer latexes used according to the disclosure are Styrene-Butadiene-Rubber (SBR), Ethylene-Vinyl-Chloride (EVCl), PolyVinylidene Chloride (PvdC), modified PolyVinyl Chloride (PVC), PolyVinyl Alcohol (PVOH), and PolyVinyl Acetate (PVA). The glass fibers, non-glass filler material and non-asphaltic binder are all mixed together to form the facer sheets.

U.S. Pat. No. 4,745,032 discloses an acrylic coating comprised of one acrylic underlying resin which includes fly ash and an overlying acrylic resin which differs from the underlying resin.

U.S. Pat. No. 4,229,329 discloses a fire retardant coating composition comprising fly ash and vinyl acrylic polymer emulsion. The fly ash is 24 to 50% of the composition. The composition may also preferably contain one or more of a dispersant, a defoamer, a plasticizer, a thickener, a drying agent, a preservative, a fungicide and an ingredient to control the pH of the composition and thereby inhibit corrosion of any metal surface to which the composition is applied.

U.S. Pat. No. 4,784,897 discloses a cover layer material on a basis of a matting or fabric which is especially for the production of gypsum boards and polyurethane hard foam boards. The cover layer material has a coating on one side which comprises 70% to 94% powdered inorganic material, such as calcium carbonate, and 6% to 30% binder. In addition, thickening agents and cross-linking agents are added and a high density matting is used.

U.S. Pat. No. 4,495,238 discloses a fire resistant thermal insulating composite structure comprised of a mixture of from about 50% to 94% by weight of inorganic microfibers, particularly glass, and about 50% to 6% by weight of heat resistant binding agent.

U.S. Pat. No. 5,965,257, issued to the present assignee, the entire disclosure of which is incorporated herein by reference, discloses a structural article having a coating which includes only two major constituents, while eliminating the need for viscosity modifiers, for stabilizers or for blowing. The structural article of U.S. Pat. No. 5,965,257 is made by coating a substrate having an ionic charge with a coating having essentially the same iconic charge. The coating consists essentially of a filler material and a binder material. The assignee, Elk Corporation of Dallas, produces a product in accordance with the invention of U.S. Pat. No. 5,965,257 which is marketed as VersaShield®.

As indicated in U.S. Pat. No. 5,965,257, VersaShield® has many uses. However, it has been found that the products made in accordance with U.S. Pat. No. 5,965,257 are not satisfactory for certain uses because they lack sufficient drapability.

U.S. patent application Ser. No. 09/955,395, filed Sep. 18, 2001, also assigned to the present assignee, the entire disclosure of which is incorporated herein by reference, addresses these inadequacies with a fire resistant fabric material comprising a substrate having an ionic charge coated with a coating having essentially the same ionic charge wherein the coating comprises a filler component which includes clay and a binder component. The fire resistant fabric material thus produced has satisfactory flexibility, pliability and drapability characteristics. However, while this material is suitable as a fire resistant fabric material, it is desirable to provide a fire resistant material that would also have cushioning or “bounceback” characteristics.

In accordance with the present invention, a layer of structural material comprising a surfactant component, surfactant-generated microcells, a filler component and a binder component is formed, preferably on a substrate forming a fabric material, or alternatively as a free standing sheet. Both the fabric material and the free standing sheet are highly fire resistant and when combined with a decorative fabric outer layer, provide decorative, fire-resistant fabrics having characteristics suitable for use in mattresses, draperies, furniture upholstery and the like.

### SUMMARY OF THE INVENTION

The present invention relates to structural material comprising a surfactant component, surfactant-generated microcells, a filler component and a binder component. The structural material is fire resistant and is useful, inter alia, for making fire resistant fabric materials which comprise a substrate coated with a coating comprising the structural materials of the present invention. The fabric materials of the present invention may be planar and may have on one or both sides of the substrate coated with the structural materials of the present invention. The fabric materials may further include a water repellent material, an antifungal material, an antibacterial material, a surface friction agent, a flame retardant material and/or an algaecide. Further, the fabric materials may be colored with dye.

The present invention also relates to a mattress fabric comprising a decorative fabric and a fabric material comprising a substrate coated with the structural materials of the present invention. Moreover, the present invention relates to a mattress comprising a decorative fabric and a fabric material comprising a substrate coated with the structural materials of the present invention.

In a particularly preferred embodiment, the coating does not bleed through the substrate during the material making process. The substrate may be any suitable reinforcement material capable of withstanding processing temperatures and is preferably woven fiberglass. The binder is preferably acrylic latex and the filler preferably comprises clay. The surfactant may be any surfactant capable of forming microcells. In a preferred embodiment, the surfactant is a fast soap, such as ammonium lauryl sulfate (ALS). A fast soap generates microcells quickly in quantity and/or volume.

The structural fire resistant material of the present invention may be used as a standalone product, for example, as a fire resistant foam material, or it may also be used in conjunction with (e.g. as a liner for) a decorative fabric which may itself be fire resistant. The present invention also relates to an article of manufacture comprising the inventive structural material and/or the inventive fire resistant fabric materials and includes, inter alia, mattress fabrics, mattress covers, mattresses, upholstered articles, building materials, bedroom articles, (including children's bedroom articles), draperies, carpets, tents, awnings, fire shelters, sleeping bags, ironing board covers, barbecue grill covers, fire resistant gloves, airplane seats, engine liners, and fire-resistant clothing for race car drivers, fire fighters, jet fighter pilots, and the like. The use of the fire resistant materials and fire resistant fabric materials of the present invention for manufacturing fabrics for use in articles such as mattresses, cribs, draperies, and upholstered furniture, may enable the article to exceed current flammability standards for these types of articles.

### BRIEF DESCRIPTION OF THE FIGURES

The present invention may be better understood with reference to the attached figures in which—

FIG. 1 is a graph showing the results of the California TB129 flammability test indicating the heat release rate (HRR) for various embodiments of the mattresses made in accordance with the present invention (* indicates extended 60 minute test) and for a control mattress;

FIG. 2 is a graph showing the results of the California TB129 flammability test indicating the total heat released for various embodiments of the mattresses made in accordance with the present invention (* indicates extended 60 minute test) and for a control mattress;

FIG. 3 is a graph showing the results of the California TB129 flammability test indicating the weight loss for various embodiments of the mattresses made in accordance with the present invention (* indicates extended 60 minute test) and for a control mattress;

FIGS. 4A and 4B are respectively photographs of a control mattress before and after a 3 minute California TB129 flammability test procedure;

FIG. 5A is a photograph of a mattress made in accordance with a preferred embodiment of the present invention before and after a 3 minute California TB129 flammability test procedure and 5B is a photograph of a mattress made in accordance with a preferred embodiment of the present invention before and after a 60 minute California TB129 flammability test procedure;

FIG. 6 is a graph showing the softness rating of various embodiments of the mattresses of the present invention and of a control mattress;

FIG. 7 is a photograph showing the surfactant-generated microcells of an exemplary embodiment of a fire resistant fabric material of the present invention;

FIG. 8 is a photograph showing the surfactant-generated microcells of another exemplary embodiment of the present invention; and

FIG. 9 is an illustration of an exemplary embodiment of a mattress of the invention.

### DETAILED DESCRIPTION

The structural material of the invention comprises a surfactant component, surfactant-generated microcells, a filler component and a binder component. As used herein, surfactant-generated microcells are essentially voids or hollow spheres which are formed by the presence of a surfactant during the fire resistant material making process. Thus, the surfactant components of the present invention are capable of forming microcells. The surfactant-generated microcells impart various characteristics to the fabric materials of the present invention, including, inter alia, improved fire resistance, flexibility, pliability, drapability and “bounce back”.

In accordance with the invention, a fabric material is made by coating a substrate with a coating comprising the aforementioned structural material. In a preferred embodiment, the coating does not bleed through the substrate during the fabric material making process.

The filler component of the present invention preferably includes clay. The clay is preferably China clay which is very soft and light. Alternatively, the clay may be Paragon™, which is also a soft clay (i.e. it is soft to the touch), Suprex™, which is a hard clay (i.e. it is hard to the touch), Suprex™ amino silane treated clay, which is used for crosslinking because it will chemically bond with binder and also for highloading, Ballclay™, which has elastic properties (i.e. it feels rubbery), Texwhite 185 (available from Huber, Dry Branch, Ga.), and ECC 1201 (available from Huber). All of above-listed clay products, unless otherwise noted, are available, for example, from Kentucky-Tennessee Clay Company of Langley, S.C. In one embodiment, the clay is Ballclay™ 3380 which is particularly inexpensive compared to other clays. In a preferred embodiment, the clay is Kaolin clay which is a lower grade China clay. In particularly preferred embodiments, the clay is Texwhite 185 and/or ECC 1201 (see Table I and Table II below).

In the present invention, clay is a preferred filler because of its elongation properties (it has a low modulus), its abrasion resistance, its tear resistance, and its tensile strength. Moreover, clay is a good heat barrier; it does not disintegrate when an open flame (temperature≧1500° F.) is applied directly to a coating of the present invention that includes clay. In addition, clay provides a slick, elastic, glassy surface which exhibits flexibility. Furthermore, as noted, clay is inexpensive and can help to keep the cost of the fabric material low.

The filler material may alternatively or additionally comprise a filler selected from the group consisting of decabromodiphenyloxide, antimony trioxide, calcium carbonate, charged calcium carbonate, titanium dioxide, fly ash (such as Alsil O4TR™ class F fly ash produced by JTM Industries, Inc. of Martin Lake and Jewett, Tex. which has a particle size such that less than 0.03% remains on an agitated 0.1 inch×0.1 inch screen), 3-X mineralite mica (available from Engelhard, Inc. of Louisville, Ky.) and glass or ceramic microspheres (glass microspheres are 2.5 times lighter than ceramic microspheres and also provide fire resistance), or any mixture of these filler materials to meet desired cost and weight criteria. Glass and ceramic microspheres are manufactured by Zeelan Industries of 3M Center Bldg., 220-8E-04, St. Paul, Minn. 55144-1000. Calcium carbonate may be obtained from Franklin Industrial Minerals of 612 Tenth Avenue North, Nashville, Tenn. 37203.

Calcium carbonate, talc and fly ash filler increase the weight of the product, but utilization of glass and/or ceramic microspheres enables the manufacture of a product with reduced weight and increased fire resistant properties. Clay may impart to the product the following nonlimiting characteristics: (1) lower heat build-up, (2) heat reflectance properties, (3) fire barrier properties, (4) no weight loss when exposed to heat and open flame, and (5) reduced disintegration when exposed to heat and open flame. Decabromodiphenyloxide and antimony trioxide impart the following nonlimiting characteristics: (1) flame retardant properties, (2) capability of forming a char, and (3) capability of stopping the spread of flames. It is believed that the gas produced from the heating of the decabromodiphenyloxide can also act as a flame retardant because the gas uses up oxygen or depletes oxygen in the layer next to the fabric and suppresses or stops the fire from further progression.

Glass and ceramic microspheres can withstand heat greater than 2000° F. Also, glass and ceramic microspheres increase compressive strength, absorb no latex and/or water and thus permit the faster drying of the product. Glass and ceramic microspheres also increase product flexibility.

Further, the glass and ceramic microspheres help to increase the pot life of the coating. Heavier particles in the fillers, although they may comprise but a small percentage of the particles in the filler, have a tendency to settle near the bottom of a storage vessel. When glass and/or ceramic microspheres are mixed together with another filler, a dispersion is produced which has an increased pot life or shelf life. Without wishing to be bound by any particular theory, it is believed that as the filler particles naturally fall in the vessel and the glass and ceramic microspheres rise, the smaller size filler particles are supported by the glass and/or ceramic microspheres, thus enabling the microspheres to stay in solution and preventing the filler particles, to at least some extent, from descending to the bottom of the vessel.

The structural material of the present invention is prepared by using a binder component such as a high performance heat-reactive acrylic latex polymer and/or a non-heat reactive styrene butadiene latex to bond the filler materials together. Where the structural material is used to coat a substrate, the binder component also acts to bond the filler to the substrate. In one embodiment of the invention, the binder component is Rhoplex 3349 (Rohm and Haas, Philadelphia, Pa.) and/or Rovene 4402 (Mallard Creek Polymer, Inc. Charlotte, N.C.). Additional or alternative binders include, inter alia, Hycar™ 26469, Hycar™ 26472, Hycar™ 26484, Hycar™ 26497, Hycar™ 264552, Hycar™ 264512, Hycar™ 264582, Hycar™ 26083 (low formaldehyde), Hycar™ 9201 (low formaldehyde), Hycar™ 1552 (nitrile), Hycar™ 1571 (nitrile), Vycar™ 552, Hycar™ 2679 acrylic latex polymer (all Hycar™ and Vycar™ products are supplied by B. F. Goodrich Company of Cleveland, Ohio). Binder components may also include Cymel™ 373 (available from American Cyanamid), RHOPLEX™ TR 407 and R&H GL-618 latex both available from Rohm & Haas, and Borden FG-413F UF resin (available from Borden). It is believed, however, that any linear polymer, linear copolymer or branched polymer may be useful in preparing the coating, such as those available from BASF and Goodyear. Further possible binder materials include butyl rubber latex, SBR latex, neoprene latex, polyvinyl alcohol emulsion, SBS latex, water based polyurethane emulsions and elastomers, vinyl chloride copolymers, nitrile rubbers and polyvinyl acetate copolymers. In a preferred embodiment, an SBR latex is used. SBR latex adds good softness characteristics but is not a flame retardant. To improve fire resistance, an acrylic latex may be added or substituted. The more acrylic latex, the better the fire resistance of the material. However, softness is decreased as the SBR latex is substituted.

The surfactant component of the present invention may be any surfactant capable of forming microcells during the fire resistant material making process. In a preferred embodiment, the surfactant comprises a soap, such as ammonium lauryl sulfate (ALS) (e.g. Stepanol AM; Stepan Chemicals, Northfield, Ill.) and sodium lauryl sulfate (SLS) which are capable of modifying the surface tension of a solvent, such as water. Such surfactants may be referred herein as “fast soaps.” Generally, a “fast soap” is a soap which is capable of efficiently modifying the surface tension of a solvent, such as water. However, other surfactants may also be used which are not characterized as fast soaps but which are capable of forming microcells. Fast soaps, such as ALS, form microcells that are resilient and are generally stable to the heat of processing. Additional components may be added to further stabilize the microcells, as further discussed below. However, if so desired, a surfactant which forms “weak” microcells may be used. The “weak” microcells may burst during processing to produce a less flexible fire resistant material.

In one embodiment of the present invention, the structural material is made by combining the binder component, the surfactant component and the filler component together and creating surfactant-generated microcells. Surfactant-generated microcells may be created by any means known in the art, such as, but not limited to, blowing air into the mixture, agitation or by a foamer. Surfactant-generated microcells may also be introduced using chemical blowing agents, such as azo compounds which release nitrogen.

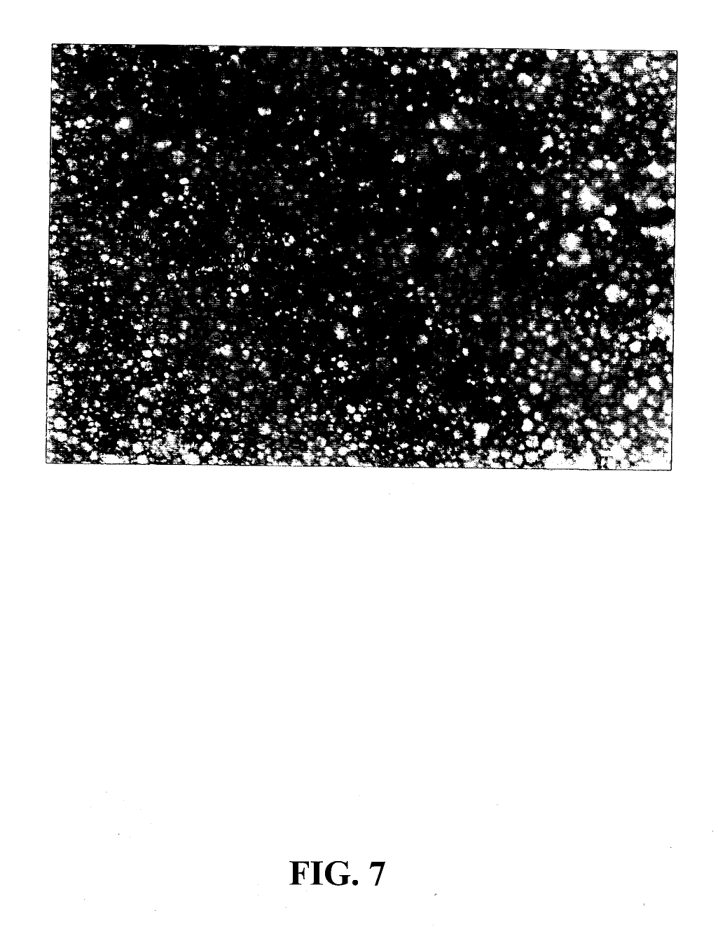

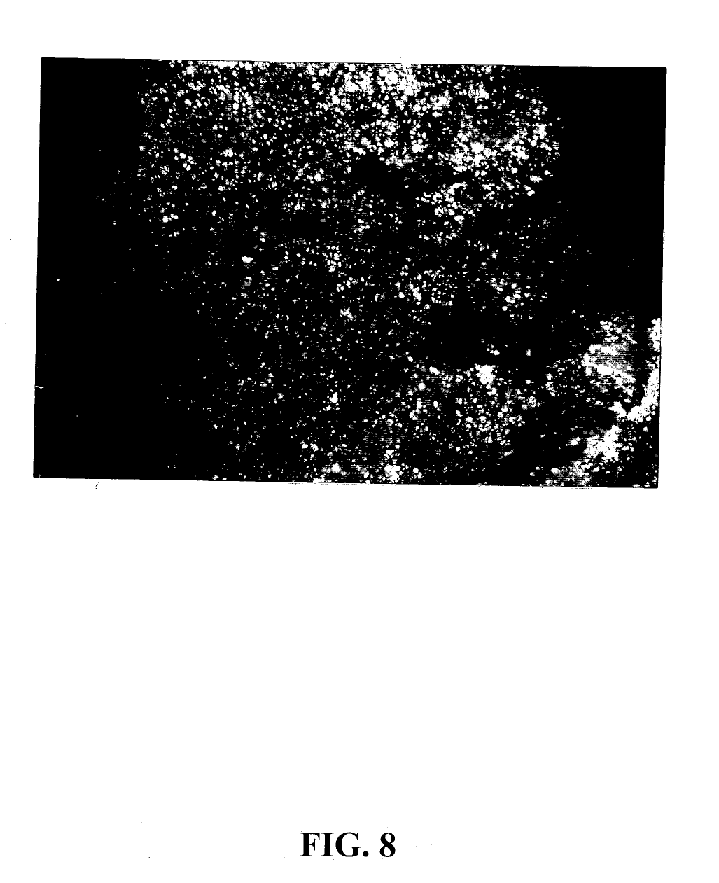

In one embodiment of the invention, the mixture is subjected to a roamer. The foamer acts to inject air into the mixture so that the surfactant forms microcells within the mixture. The roamer may comprise a tube-like component having a multitude of pins which are capable of rotating in opposing directions (e.g. some pins move clockwise and some move counterclockwise). The mixture of binder, surfactant and filler is added to the foamer through a port on one side and, as it passes through the foamer, the pins rotate causing the surfactant to form microcells. Additionally, air may also be introduced into the roamer at another port to further enhance surfactant-generated microcell formation. After having been subjected to the foamer, the mixture may then be applied onto a substrate, such as a fiberglass mat. Alternatively, the mixture may be applied onto a receiving platform, such as a steel tray to form a free-standing sheet. Whether applied to a substrate or a receiving platform, the material is then subjected to heat in an oven. Processing temperatures are preferably from about 280° F. to about 350° F. In a preferred embodiment, the surfactant-generated microcells are stable to the heat of processing. Generally, the surfactant-generated microcells are not stable above 350° F. FIG. 7 and FIG. 8 show surfactant-generated microcell formation in two exemplary embodiments of the prevention. As preferred, the surfactant-generated microcells are relatively small and uniform in size.

In another embodiment of the invention, the structural material is produced with collapsed microcells. Such a material may be prepared using a surfactant capable of forming microcells but which does not efficiently modify the surface tension of water. During the heat of processing, the surfactant-generated microcells expand, due to the expansion of gases within them, burst and collapse.

In another embodiment, the fire resistant material also includes a surfactant capable of regulating surfactant-generated microcell formation. One such surfactant is Stanfex 320, (Parachem, Dalton, Ga.). The surfactant capable of regulating surfactant-generated microcell formation can ensure that the microcells remain within a preferred size range (e.g. do not get too big) and form in a relatively monodisperse state (i.e., are of the same general size). In a preferred embodiment, the surfactant-generated microcells are about 5.0μ to about 20.0μ in diameter. In addition, citric acid may be used to ensure that the surfactant-generated microcells are spread out uniformly.

It may also be desirable for the fire resistant materials to include a dispersant which acts to keep the mixture comprising the binder, surfactant and filler well dispersed during the material making process. Examples of such dispersants include, inter alia, TSPP, Accuma 9300, Accuma 9400 and Accuma 9000 (all available from Rohn & Haas).

The fire resistant fabric materials of the present invention are flexible, pliable and have good drapability characteristics. In addition they are durable and preferably do not crack upon bending. Durability of the fire resistant material may be enhanced by adding components capable of stabilizing the surfactant-generated microcells. Such components include surfactants such as ammonium stearate (available from Parachem, Dalton, Ga.), octosol A18 (Tiarco Chemicals, Dalton, Ga.), A-1 (disodium n-alkylsulfosuccinate; Tiarco Chemicals), 449 (potassium oleate, Tiarco Chemicals), and Stanfex 320. The surfactant-generated microcell may be stabilized by making the wall of the microcell thicker. A surfactant having a long waxy chain may be particularly useful for stabilizing the microcells.

The structural material may further include a cross-linking component, such as melamine (Borden Chemicals, Morganton, N.C.) and/or ammonium chloride. The cross-linking component is useful to improve durability and microcell structural strength. In order to control the amount and rate of cross-linking, it may be desired to control the pH of the mixed components. For example, in acidic conditions (pH˜4.0), the cross-linking will occur very quickly and the mixture will have a short pot-life. At higher pH (˜10.0), the cross-linking proceeds more slowly and can be controlled by heat.

The structural material of the present invention may also comprise resin which may provide a polymer shell to encapsulate air. In one embodiment, the resin is DPG-38, available from Parachem of Dalton, Ga.

In a preferred embodiment, the fire resistant material further possesses “bounceback” characteristics. As used herein, “bounceback” refers to the ability of the material to return to its original shape after having been distorted, such as stretched or compressed. In such an embodiment, additional components are added to achieve such bounceback characteristics. These components may coat the inside of the microcell such that the microcell reverts to its original shape after having been distorted. Preferred components useful for achieving bounceback characteristics include CT101 (silicon oil; Kelman Industries, Duncan, S.C.), Freepel 1225 (B F Goodrich, Cleveland, Ohio), Sequapel 409 (Omnovasolutions, Inc. of Chester, S.C.), Michem emulsion 41740 (available from Michelman, Inc. of Cincinnati, Ohio), Syloff-1171A (available from Dow Corning, Corporation of Midland, Mich.), Syloff-62 (Dow Corning), Syloff-7910 (Dow Corning) and Aurapel 391 (available from Sybron/Tanatex of Norwich, Conn.). These components also ensure that the microcells do not aggregate and form clumps of microcells.

The substrate of the present invention may be any suitable reinforcement material capable of withstanding processing temperatures, such as glass fibers, polyester fibers, cellulosic fibers, asbestos, steel fibers, alumina fibers, ceramic fibers, nylon fibers, graphite fibers, wool fibers, boron fibers, carbon fibers, jute fibers, polyolefin fibers, polystyrene fibers, acrylic fibers, phenolformaldehyde resin fibers, aromatic and aliphatic polyarnide fibers, polyacrylamide fibers, polyacrylimide fibers or mixtures thereof which may include bicomponent fibers.

Examples of substrates in accordance with the invention include, inter alia, glass, fiberglass, ceramics, graphite (carbon), PBI (polybenzimidazole), PTFE, polyaramides, such as KEVLAR™ and NOMEX™, metals including metal wire or mesh, polyolefins such as TYVEK™, polyesters such as DACRON™ or REEMAY™, polyamides, polyimides, thermoplastics such as KYNAR™ and TEFZEL™, polyether sulfones, polyether imide, polyether ketones, novoloid phenolic fibers such as KYNOL™, KoSa™ polyester fibers, JM-137 M glass fibers, Owens-Corning M glass, Owens-Corning K glass fibers, Owens-Corning H glass fibers, Evanite 413M glass microfibers, Evanite 719 glass microfibers, cellulosic fibers, cotton, asbestos and other natural as well as synthetic fibers. The substrate may comprise a yarn, filament, monofilament or other fibrous material either as such or assembled as a textile, or any woven, non-woven, knitted, matted, felted, etc. material. The polyolefin may be polyvinyl alcohol, polypropylene, polyethylene, polyvinyl chloride, polyurethane, etc. alone or in combination with one another. The acrylics may be DYNEL, ACRILAN and/or ORLON. RHOPLEX AC-22 and RHOPLEX AC-507 are acrylic resins sold by Rohm and Haas which nay also may be used. The cellulosic fibers may be natural cellulose such as wood pulp, newsprint, Kraft pulp and cotton and/or chemically processed cellulose such as rayon and/or lyocell.

Nonlimiting examples of non-woven materials that may be useful in the present invention include non-woven, continuous fiberglass veils, such as Firmat™ 100, Pearlveil™ 110, Pearlveil™ 210, Curveil™ 120, Curveil™ 220, Flexiveil™ 130, Flexiveil™ 230 and Pultrudable veil (all available from Schmelzer Industries, Inc., Somerset, Ohio). The woven materials may be Airlaid™, Spunbond™ and Needlepunch™ (available from BFG Industries, Inc. of Greensboro, N.C.). Nonlimiting examples of filament materials include D, E, B, C, DE, G, H, K filaments of various grades, including electrical grade, chemical grade and high strength grade (all available from BFG Industries, Inc. of Greensboro, N.C.).

In a preferred embodiment, the substrate is a woven fiberglass mat. As used herein, a fiberglass mat includes nonwoven and woven fiberglass mats. In a particularly preferred embodiment, the substrate of the present invention is a woven fiberglass mat such as style 1625, style 1610 and style 1614 of BGF Industries (Greensboro, N.C.).

The use of the structural materials of the present invention for manufacturing fabrics for use in articles such as mattresses, cribs, drapes and upholstered furniture, may enable the article to exceed current flammability standards for these types of articles. While flammability standards for mattresses have not been specifically set by the federal or state governments, some government agencies have provided recommended guidelines.

For example, the United States Department of Commerce National Institute of Standards and Technology (NIST) in Gaithersburg, Maryland has published a paper relating to a methodology for assessing the flammability of mattresses. See T. J. Ohlemiller et al., Flammability Assessment Methodology for Mattresses, NISTIR 6497, June 2000. While no clear standard is given, it is recommended that a mattress be able to withstand the described test procedures. The NTIS has noted that beds pose a unique fire hazard problem. It provides a series of tests for determining the flammability of mattresses.

In addition, the State of California Department of Consumer Affairs Bureau of Home Furnishings and Thermal Insulation (“the Bureau”) issued a Technical Bulletin in October 1992 which provides a flammability test procedure for mattresses. See State of California Department of Consumer Affairs Bureau of Home Furnishings and Thermal Insulation Technical Bulletin 129, October 1992, Flammability Test Procedure for Mattresses for use in Public Buildings (California TB129). The technical bulletin provides standard methods for fire testing of mattresses. The methods produce data describing the burning behavior from ignition of a mattress until all burning has ceased, or after a period of one hour has elapsed. The rate of heat release is measured by an oxygen consumption technique. The Bureau indicates that mattresses complying with the test method will be safer and hopes that manufacturers will attempt to manufacture mattresses which pass the recommended tests. The Bureau indicates that “a mattress fails to meet the requirements of the test if any of the following criteria are exceeded:” (1) a maximum rate of heat release of 100 kW or greater, (2) a total heat release of 25 MJ or greater in the first 10 minutes, and (3) weight loss of 3 pounds or greater within the first 10 minutes due to combustion.

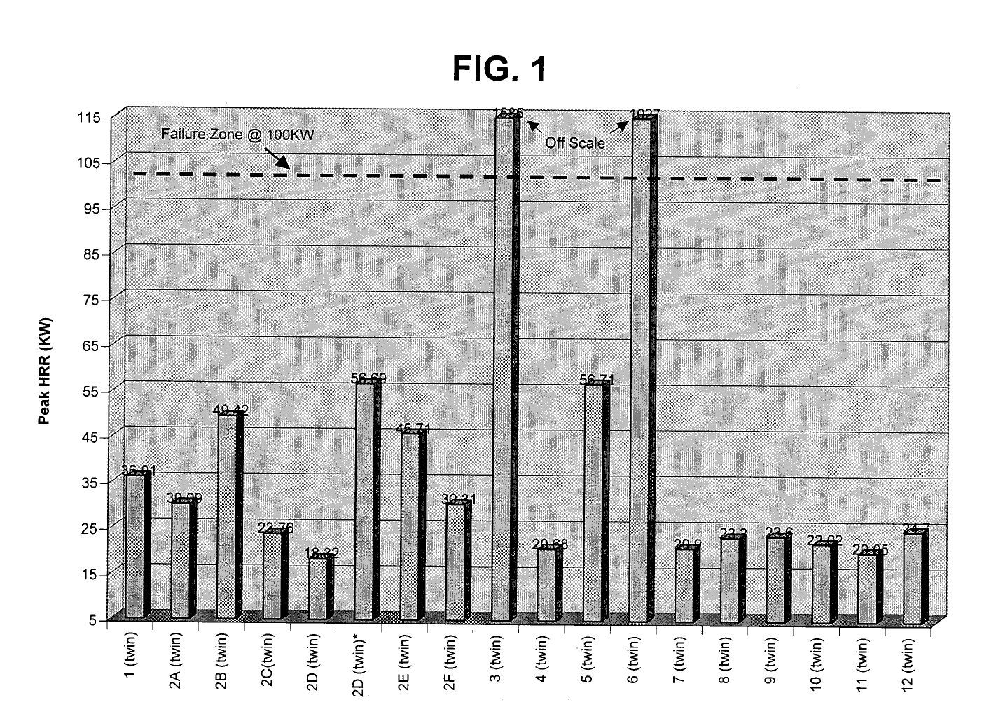

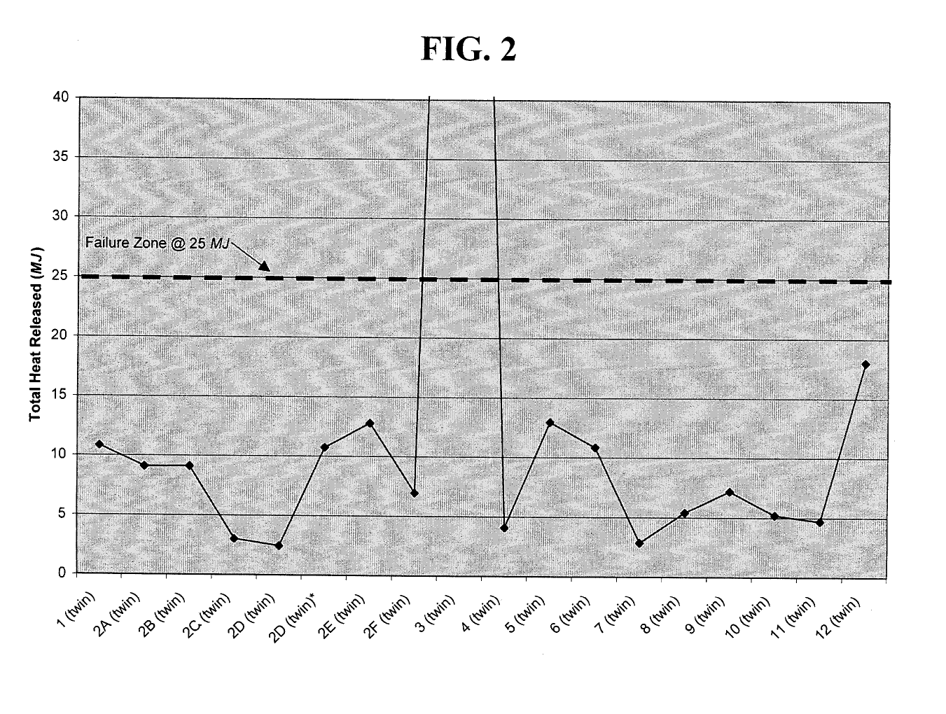

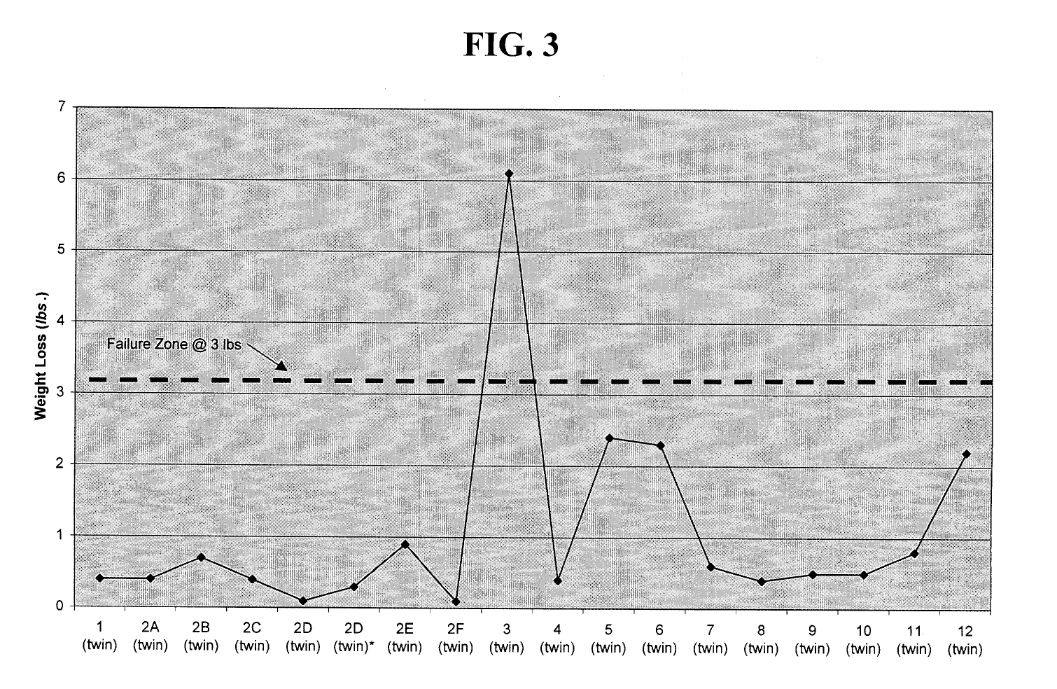

A mattress manufactured with the fire resistant fabric material of the present invention complies with or exceeds the test standards recommended by both the NTIS and the California TB129. See Example 1 and Example 2 below. FIGS. 1-3 and Table III below show the results of a California TB129 flammability test for mattresses comprising the fire resistant fabric materials of the present invention. See also Example 2 below. According to the California TB129, a peak heat release rate of greater than 100 KW is a failure. FIG. 1 shows that the mattresses of the present invention, with the exception of Mattress 6 (see Table III) had a peak heat release rate of between 18.32 to 56.71 KW, well below the failing range. In addition, a total heat release of greater than 25 MJ constitutes a failure. FIG. 2 shows that a control mattress (#3 twin) has a total heat release of 129.79 MJ, whereas the mattresses of the present invention had total heat releases of between 2.45 and 18.0, all well below the failing range. According to the California TB129, weight loss can not exceed 3 pounds. FIG. 3 shows that the control mattress had a weight loss of 6.1 pounds, whereas the mattresses made with the fire resistant fabric material according to the present invention had weight losses in the range of 0.1 to 2.4 pounds, also below the failing range.

As indicated above, the fire resistant fabric material of the present invention is useful in the manufacture of mattresses. In this embodiment of the invention, the fire resistant fabric material may be used to line a decorative mattress fabric to produce a fire resistant mattress fabric. Nonlimiting examples of mattress fabrics include ticking (known in the art as a strong, tightly woven fabric comprising cotton or linen and used especially to make mattresses and pillow coverings), or fabrics comprising fibers selected from the group consisting of cotton, polyester, rayon, polypropylene, and combinations thereof. The lining may be achieved by methods known in the art. For example, the fire resistant fabric material of the present invention may simply be placed under a mattress fabric. Or, the fire resistant mattress material may be bonded or adhered to the mattress fabric, for example using a flexible and preferably nonflammable glue or stitched with fire resistant thread i.e., similar to a lining. The fire resistant mattress fabric of the present invention may then be used by the skilled artisan to manufacture a mattress which has improved flammability characteristics.

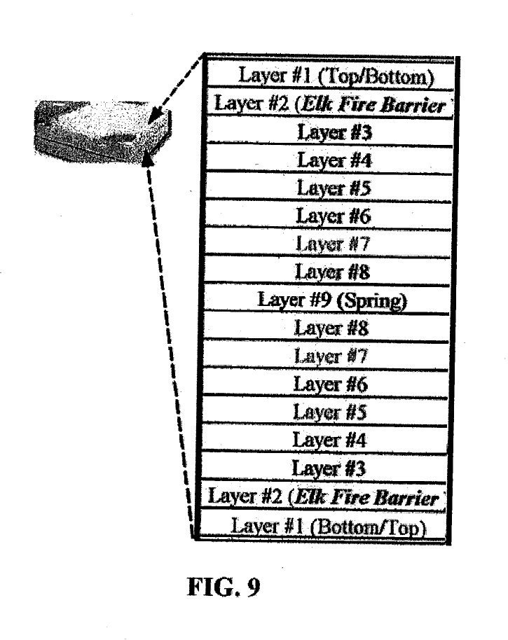

The mattresses of the present invention which comprise the fire resistant fabric material may be comprised of several layers, including, but not limited to at least one first layer which comprises a fabric layer (such as the mattress fabrics discussed above), at least one layer which comprises the fire resistant fabric material of the present invention (which may, for example be a second layer or a third layer), at least one cushion layer, a polyurethane foam layer, a non-woven sheeting layer and a layer comprising springs. See, e.g. Example 2 below, and particularly Mattresses 1, 2A-2F, 4, 5 and 6 and FIG. 9. The layer comprising the fire resistant fabric material of the present invention, as indicated above, comprises a substrate and a coating. In one embodiment, the fire resistant fabric material is coated on one side and the side with the coating is facing the first layer. However, as indicated above, the fire resistant fabric material may be coated on both sides.

In a particular embodiment of the invention, the mattress comprises at least one first layer comprising a mattress fabric and at least one second layer adjacent to the first layer and comprising the fire resistant fabric material of the present invention. See, e.g., Example 2 below, particularly Mattresses 1, 2A-2F and 4. The fabric of the first layer may be the mattress fabric discussed above, such as ticking, or a fabric comprising fibers selected from the group consisting essentially of cotton, polyester, rayon, polypropylene, and combinations thereof. See Example 2 below.

The non-woven sheeting layer may be any suitable material known in the art. For example, the non-woven sheet layer may be made from any noncombustible fibers. In a preferred embodiment, the non-woven sheet layer is made from fiberglass fibers. The mattress of the present invention may further comprise at least one third layer adjacent to the second layer and at least one fourth layer adjacent to the third layer wherein each of the third and fourth layers is a cushion layer and at least one fifth layer adjacent to the fourth layer and which comprises polyurethane foam. See Example 2 below, Mattress 2A-2F. The cushion layer may be made of polyester fibers or any fibers known in the art to be suitable for making a layer which provides cushioning. The polyurethane foam may be of varying thickness. Furthermore, the mattress of the present invention may comprise at least one sixth layer adjacent to the fifth layer and comprising the fire resistant fabric material. See Example 2 below, Mattress #1.

Mattresses #6-11 in Example 2 below feature varying amounts of polyester fiber as the second layer of the mattress between the ticking first layer and the inventive fire resistant fabric third layer. In another embodiment of the invention, the polyurethane foam may be the second layer of the mattress (i.e. under the ticking and in place of polyester fiber). See Table III and Mattress 12, below. The polyurethane foam layer provides a superior cushioning effect. However, the total weight of the polyurethane foam layer together with the ticking must be less than 3 lbs, because the ticking and the polyurethane foam will burn and the mattress will not pass the burn tests if more than 3 lbs is lost. In such an embodiment, a preferred thickness for the foam is 0.25 inches. See Table III and Mattress 12, below.

The mattress of the present invention may further comprise a fire resistant border. In one embodiment, the border of the present invention comprises a first layer comprising a mattress fabric and a second layer adjacent to the first layer and comprising the fire resistant fabric material of the present invention. In addition, the border may comprise a third layer adjacent to the second layer and which comprises a polyurethane foam. The border may also comprise a fourth layer, adjacent to the third layer, and which comprises a non-woven sheet. Alternatively, the border may comprise a fourth layer, adjacent to the third layer, and which comprises the fire resistant fabric material of the present invention and a fifth layer, adjacent to the fourth layer, and which comprises a non-woven sheet.

In another embodiment of the present invention, the mattress comprises at least one first layer comprising a mattress fabric, at least one second layer, adjacent to the first layer, and which comprises the fire resistant fabric material of the present invention, at least one third layer adjacent to the second layer, and which comprises polyurethane foam, at least one fourth layer adjacent to the third layer, and which comprises a non woven sheet, at least one fifth layer adjacent to the fourth layer and which comprises a fibrous pad and at least one sixth layer adjacent to the fifth layer and which comprises another fibrous pad. This embodiment is further exemplified in Example 2 below, Mattress 5. All of the aforementioned embodiments of the mattress of the present invention passed all fire tests. See Example 2 below.

In a preferred embodiment, the mattress of the present invention comprises at least one first layer which comprises a mattress fabric, at least one second layer adjacent to the first layer wherein the second layer is a cushion layer, and at least one third layer adjacent to the second layer, and which comprises the fire resistant fabric material of the present invention. The mattress may further comprise a at least one fourth layer adjacent to the third layer and wherein the fourth layer is a cushion layer, at least one fifth layer, adjacent to the fourth layer, and which comprises polyurethane foam, and at least one sixth layer, adjacent to the fifth layer, and which comprises a non-woven sheet. The cushion layer may be made from any fiber known in the art suitable for making a cushion. In a preferred embodiment, the cushion layer comprises polyester fibers. The best embodiment from a comfort standpoint included as the second layer a two ounce polyester fiber layer. This embodiment of the invention is exemplified in Example 2 below, Mattress 6. This embodiment resulted in a mattress with softness superior to control mattresses (see Example 2 below, Control Mattress 3), but, as noted above, it had poor fire resistant characteristics. However, Layer #2 of mattress 6 had a total weight of greater than 3 lbs. Therefore, because more than 3 lbs. were lost during the burn test, the mattress did not pass. Nonetheless, superior softness may be achieved when the second layer is a polyester fiber or a polyurethane foam and the total weight of the layer together with the ticking is less than 3 lbs. This preferred embodiment is Exemplified in Example 2 below, Mattresses 7-12.

As indicated above for certain embodiments of the mattresses of the present invention, the coating of the fire resistant fabric material faces the first layer. As used herein, “faces the first layer” means that the fire resistant fabric material has a coating on one or both sides. If the coating is on one side, that side faces the first layer, with the uncoated side facing away from the first layer. In addition, the numbers of the layers indicates the order of the layers. For example, if the mattress fabric is the first layer, this layer is the top of the mattress, with the second layer being adjacent to the first layer, the third layer is adjacent to the second layer, and so on.

In addition to the layers described above, the mattresses of the present invention may comprise other layers which may comprise one or more fibrous pad layers and/or a spring layer. See, e.g., Example 2 below. The mattresses also may comprise a border, such as the border described above. See, e.g., Example 2 below. Further materials which may be incorporated into the mattress of the present invention include construction materials, such as non fire retardant or fire retardant thread for stitching the mattress materials together (e.g. glass thread or Kevlar thread) and non-fire retardant or fire retardant tape. Silicon may be used with Kevlar thread to diminish breakage and enhance production time. In a particularly preferred embodiment of the present invention, conventional tape and/or conventional thread may be used and the mattress still complies with the California TB129 test requirements. See Example 2 below and mattresses 10 and 11.

The fire resistant materials of the present invention may be used to produce materials with similar characteristics to foam and cushion layers used in mattresses and may replace or be added in addition to such layers. In such an embodiment, the foam and cushioning layers made with the fire resistant materials of the present invention impart fire resistance to the mattress when used therein.

Table I below provides, in approximate percentages, the components of the coating the applicants have used in a preferred embodiment of fire resistant fabric material of the invention.

TABLE I

| Coating Components | % Wet |
|---|---|
| BINDER | |
| Rhoplex 3349 | 34.76 |
| TR407 | 3.96 |
| FILLER | |
| Clay ECC 1201 (Huber) | 42.07 |
| SURFACTANT | |
| Octosol A18 | 3.0 |
| Ammonium Stearate | 4.27 |
| CROSS-LINKER | |
| Melamine | 1.18 |
| MISCELLANEOUS | |
| Ammonium Nitrate | 0.12 |
| Aquamix 519 | 7.0 |
| Acrysol ASE-95NP | 0.2 |
| Water | 3.46 |
| Total Percentage | 100% |

SUBSTRATE = BGF Industries Style 1625 fiberglass mat

Although the table shows possible combinations of binder, filler and surfactant, it is believed that other combinations may be employed.

Table II below provides a list of components according to another preferred embodiment of the present invention.

TABLE II

| Coating Components | % Wet |
|---|---|
| BINDER | |
| Rhoplex 3349 | 21.58 |
| Rovene 4402 SBR | 21.58 |
| FILLER | |
| Clay ECC1201 (Huber) | 25 |
| Decabromodiphenyloxide | 13 |
| SURFACTANT | |
| Stepanol AM (ALS) | 0.16 |
| Octosol A-18 | 1.68 |
| Stanfex 320 | 4.27 |
| CROSS-LINKER | |
| Ammonium Chloride | 0.11 |
| Melamine | 3.49 |
| MISCELLANEOUS | |
| Acrysol ASE-95NP | 0.14 |
| Silicon Oil CT101 | 0.5 |
| Green Dye | 0.03 |
| Y250 defoamer | 0.01 |
| TSPP | 0.07 |
| Citric Acid | 0.05 |
| Tinunin 292 | 0.05 |
| Ammonium Hydroxide | 0.26 |
| Water | 8.02 |
| Total Percentage | 100.0% |

SUBSTRATE = BFG Industries Style Number 1625 fiberglass mat

The fire resistant fabric materials, as mentioned, include a substrate and a coating which comprises the structural material of the present invention. The coating (structural material) comprises approximately 34% by weight of the fire resistant fabric material. In the coating, about 44% to about 55% by weight is binder, about 0.1% to about 5.0% is surfactant, and from about 20% to about 55% is filler. In a preferred embodiment, the coating comprises about 50% binder, about 10% surfactant and about 40% filler. The filler is preferably about 25% clay. The substrate is preferably woven glass. The substrate may also be, for example, a woven fabric of DE, E, H, or G filament available from BFG Industries. The substrate is approximately 68% by weight of the fire resistant fabric material. The binder which bonds together the glass fibers is approximately 50% Rhoplex 3349 and 50% Rovene 4402, or any other suitable binder. Nonlimiting examples of suitable binders is provided herein above.

The substrate may be coated by air spraying, dip coating, knife coating, roll coating or film application such as lamination/heat pressing. The coating may be bonded to the substrate by chemical bonding, mechanical bonding and/or thermal bonding. Mechanical bonding is achieved by force feeding the coating onto the substrate with a knife.

Structural materials and fire resistant fabric materials made in accordance with this invention may be of any shape. Preferably, such articles are planar in shape. The structural materials may be used in any of a variety of products, including, but not limited to mattress/crib fabrics, mattress/crib covers, upholstered articles, bedroom articles, (including children's bedroom articles), draperies, carpets, wall coverings (including wallpaper) tents, awnings, fire shelters, sleeping bags, ironing board covers, fire resistant gloves, furniture, airplane seats and carpets, fire-resistant clothing for race car drivers, fire fighters, jet fighter pilots, and the like, building materials, such as roofing shingles, structural laminate facing sheets, building air duct liners, roofing underlayment (or roofing felt), underlayment for organic, built up roofing materials, roll roofing, modified roll products, filter media (including automotive filters), automotive hood liners, head liners, fire walls, vapor barriers etc.

The structural material may be used alone or may be used as a liner for a decorative fabric, such as the type used for mattresses, drapes, sleeping bags, tents etc. which may also be fire resistant.

In inventive fire resistant fabric materials, the substrate may be coated on one side or both sides depending on the intended application. For instance, if one side of the substrate is coated with the filler/surfactant/binder coating, the other surface can be coated with another material. In the roofing materials industry, for example, the other material may be conventional roofing asphalt, modified asphalts and non-asphaltic coatings, and the article can then be topped with roofing granules. It is believed that such roofing material could be lighter in weight, offer better fire resistance and better performance characteristics (such as cold weather flexibility, dimensional stability and strength) than prior art roofing materials.

The mixture comprising the binder, surfactant and filler may have a consistency of a light foam, such as shaving cream. It is believed that due to the low density of the mixture, the surfactant-generated microcells formed therein do not pass through the substrate when applied thereto. If desired, however, the viscosity of the coating can be increased through mixing to ensure that it does not bleed through the substrate. Nonlimiting examples of thickening agents include Acrysol ASE-95NP, Acrysol ASE-60, Acrysol ASE-1000, Rhoplex ASE-75, Rhoplex ASE-108NP, and Rhoplex E-1961, all available from Rohm & Haas.

Additionally, the fire resistant material may be coated with a water repellent material or the water repellent material may be added in the coating (i.e., internal water proofing). Two such water repellent materials are Aurapel™ 330R and Aurapel™ 391 available from Sybron/Tanatex of Norwich, Conn. In addition, Omnova Sequapel™ and Sequapel 417 (available from Omnovasolutions, Inc. of Chester, S.C.); BS-1306, BS-15 and BS-29A (available from Wacker of Adrian, Mich.); Syl-off™-7922, Syl-off™-1171A, Syl-off™-7910 and Dow Corning 346 Emulsion (available from Dow Corning, Corporation of Midland, Mich.); Freepel™-1225 (available from BFG Industries of Charlotte, N.C.); and Michem™ Emulsion-41740 and Michem™ Emulsion-03230 (available from Michelman, Inc. of Cincinnati, Ohio) may also be used. It is believed that wax emulsions, oil emulsions, silicone emulsions, polyolefin emulsions and sulfonyls as well as other similar performing products may also be suitable water repellent materials. These materials are also useful, as mentioned above, for imparting bounceback characteristics to the fire resistant material of the invention. Water repellents may be particularly preferred for example, in the manufacture of crib mattresses, for airplane seats and in the manufacture of furniture, particularly for industrial use.

A defoamer may also be added to the coating of the present invention to reduce and/or eliminate foaming during production. One such defoamer is Y-250 available from Drews Industrial Division of Boonton, N.J.

Fire retardant materials may also be added to the fire resistant materials of the present invention to further improve the fire resistance characteristics. Nonlimiting examples of fire retardant materials which may be used in accordance with the present invention include FRD-004 (decabromodiphenyloxide; Tiarco Chemicals, Dalton, Ga.), FRD-01, FR-10, FR-11, FR-12, FR-13, FR-14 (all available from Tiarco Chemicals) zinc oxide, and aluminum trihydrate (ATH).

In addition, color pigments, including, but not limited to, T-113 (Abco, Inc.), W-4123 Blue Pigment, W2090 Orange Pigment, W7717 Black Pigment and W6013 Green Pigment, iron oxide red pigments (available from Engelhard of Louisville, Ky.) may also be added to the coating of the present invention to impart desired characteristics, such as a desired color.

The additional coatings of, e.g. water repellent material or antifungal material or antibacterial material, etc., may be applied to one or both sides of fire resistant materials and fire resistant fabric materials. For example, fire resistant fabric materials comprising substrates coated on one or both sides with filler/surfactant/binder coatings could be coated on one side with a water repellent composition and on the other side with an antibacterial agent. Alternatively, the water repellent material, antifungal material, antibacterial material, etc., may be added to the coating before it is used to coat the substrate.

### EXAMPLES

### Example 1

Fire Resistant Fabric Material

To produce the structural materials of the present invention, the applicant formulated the coating using just four major components, water, filler, surfactant and binder (see Table I above). The amounts of the major constituents were as follows: approximately 34.76% Rhoplex 3349 (Rohm & Haas, Philadelphia, Pa.), 42.07% ECC 1201 clay (Huber), and 3% octosol A18 (surfactant). In addition, 4.27% ammonium strearate, 0.12% Ammonium nitrate, 1.18% melamine, 7% Aquamix, 3.96% TR407 and 0.2% Acrysol ASE-95NP were also added. The materials were mixed in a reaction or mixing kettle for 45 minutes.

The mixture was used to coat a fiberglass mat on one and both sides. The mat was manufactured by BFG Industries, Inc. of Greensboro, N.C. and was style number 1625 and had a basis weight in the range of 1.8 lb./sq. to 1.9 lb./sq. The mat had a porosity in the range of 600 to 650 cfm/ft². The coated article was durable and flexible and did not crack on bending and possessed “bounceback” characteristics. Typical tensile strength measurements for uncoated versus coated were 47 lbs/3″ and 171 lbs/3″ respectively. Typical Elmendorff tear strength measurements were ≧3400 grams without the sample tearing.

The fire resistant fabric material was checked for combustibility. When exposed to the flame of a Bunsen Burner from a distance of two inches, woven fabric and wet lay fabric failed the fire test (i.e. the glass fiber melted or a hole was created where the flame hit the fabric). However, when the fire resistant fabric material of the present invention was exposed to the flame of a Bunsen Burner from a distance of two inches for a period of five minutes or more, no hole was created and the glass fibers did not melt. The coating protected the glass fabric from melting or disintegrating and the integrity of the glass fabric structure was maintained. In addition, when cotton was laid on top of the fire resistant fabric material such that the fire resistant fabric material was between the cotton and the Bunsen burner, it also was protected from the flame of the Bunsen burner.

The Technical Bulletin 129 of the State of California Department of Consumer Affairs Bureau of Home Furnishings and Thermal Insulation (October 1992) indicates that a fabric should maintain integrity when exposed to an open flame for 20 minutes and that test was passed in the lab with the fire resistant fabric material of the present invention and the mattresses of the present invention which comprise the fire resistant fabric material.

The invention provides a fire resistant fabric material which is flexible, pliable, has good drapability characteristics and which shows no signs of cracking, etc. The fabric material has a porosity of less than 18 cfm (uncoated has a porosity of 440 cfm) and may adhere very well to other materials, including decorative fabrics, polyurethane foam, isocyanurate foam, asphaltic compounds, and granules (non-asphaltic shingle components).

The fire resistant fabric material may have few pinholes or may have numerous pinholes and still maintain a porosity of less than from approximately 10 to approximately 50 cfm when coated with solvent based adhesive such as Firestone Bonding Adhesive BA-2004 which does not bleed through the fire resistant fabric material.

The application of the coating to the substrate was accomplished by knife coating. In addition, the coating may also be performed by, frothing and knife coating, foaming and knife coating, foaming and knife coating and crushing, dip coating, roll coating (squeezing between two rolls having a gap that determines the thickness of the coating), by a hand-held coater which can be obtained from the Gardner Company, spraying, dipping and flow coating from aqueous or solvent dispersion, calendering, laminating and the like, followed by drying and baking, as is well known in the art.

After coating, the samples were placed in an oven at approximately 350° F. for about 20 minutes to achieve drying and curing. Additionally, the coating may be separately formed as a film of one or more layers for subsequent combination with a substrate.

### Example 2

Mattresses Comprising the Fire Resistant Fabric Material

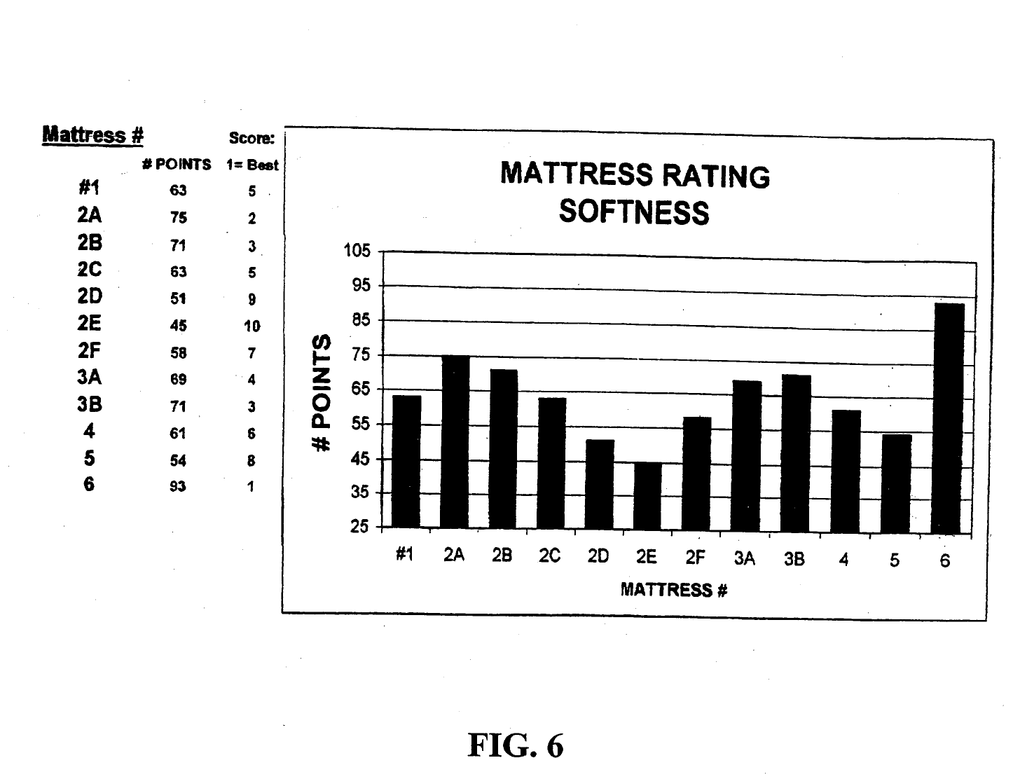

Exemplary embodiments of the mattresses of the present invention were produced comprising various layer components using the fire resistant fabric material of Example 1 above, as further detailed below (mattresses 1-12). The mattresses were tested for flammability and for comfort (softness). All mattresses listed below passed flammability tests (except Mattress 6) and were comparable in comfort to the control Mattress 3 which does not include the fire resistant fabric material of the present invention. FIG. 6 shows the softness rating for the exemplary mattresses of the invention and shows that Mattresses 1, 2A, 2B and 2C are virtually the same in softness as the control Mattress 3. Mattresses 2D, 2E, 2F, 4 and 5 rated slightly lower in softness than the control mattress, and Mattress 6 significantly exceeded the softness rating of the control mattress. The mattresses were subjected to the California TB129 Flammability test procedures. The test procedure is designed to evaluate mattresses intended for use in public buildings.

The test procedure was performed as follows. All instrumentation was zeroed, and calibrated prior to testing. Each test mattress, after conditioning to 73° F. and 50% R.H., was placed on a steel frame, on a load cell platform along the far side of the test room. A propane burner was placed centrally and parallel to the bottom horizontal surface of the mattress 1 inch from the vertical side panel of the mattress. The computer data acquisition system was started, then the burner was ignited and allowed to burn for 180 seconds. The test was continued until either all combustion ceased or one hour had passed. The mattress is regarded as failing the test if any of the following criteria are exceeded: (1) weight loss of 3 pounds or greater in the first 10 minutes; (2) maximum rate of heat release of 100 KW; and (3) total heat release of 25 MJ in the first 10 minutes.

FIGS. 1-3 show that all the mattresses, with the exception of Mattress 6 were well within the acceptable limits for heat release rate (KW), total heat released (KJ) and weight loss (lbs). Mattress 6 did not pass the heat release rate test (or the total emissions test). However, it is believed that Mattress 6 would pass the test by changing the polyester fiber used in the second layer of Mattress 6. For example, Mattress 7-11 use less polyester fiber allowing the mattress to pass the heat release rate test (or total emission of energy test) while not sacrificing the added comfort achieved with the two ounce polyester fiber. In addition, Mattress 12 uses a polyurethane foam in place of the polyester fiber and still achieves improved softness while passing the heat release test. This is because the total weight loss is less than three pounds. Table III below shows a summary of the results of the California TB129 test.

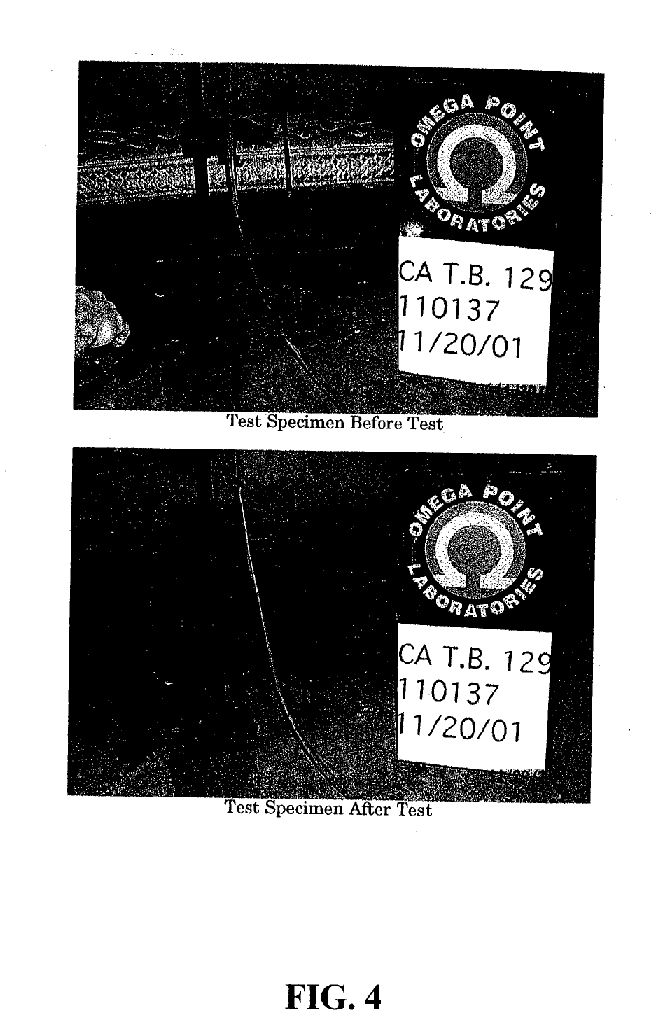

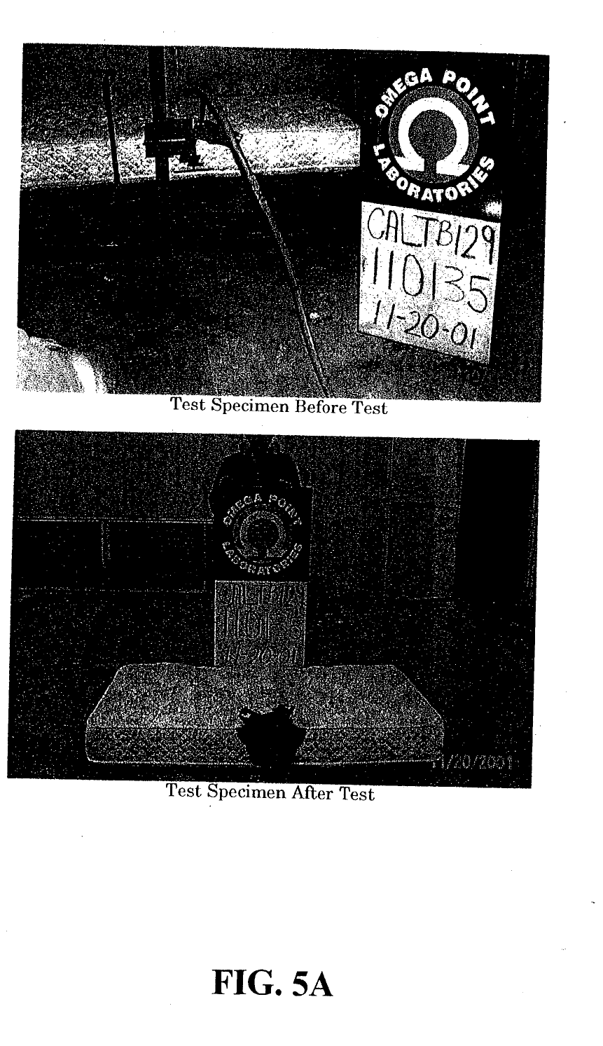

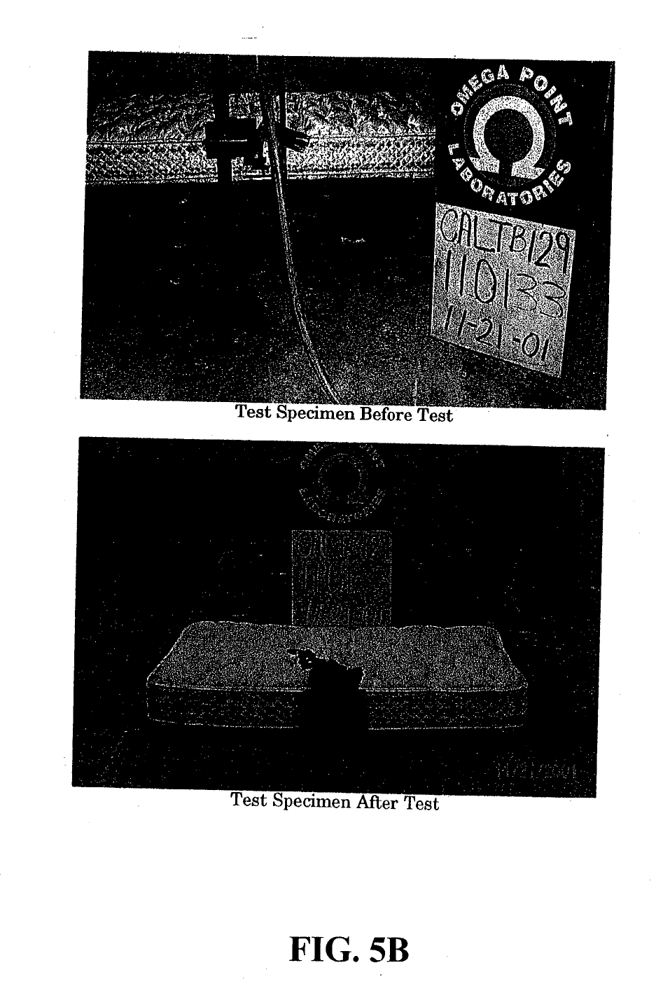

Notably and remarkably, even when exposed to a flame for 60 minutes, rather than the suggested 3 minutes of the California TB129 test, particular embodiments of the present invention still pass the requirements of the California TB129 test. See Table III, Mattresses 1 and 2d. FIG. 4 shows that a control mattress (Mattress 3 below) was completely burned during a 3 minute California TB129 test. In stark contrast, under the same conditions, FIG. 5A shows that a mattress made in accordance with the present invention (Mattress 2F below) had little fire damage. Moreover, FIG. 5B shows that a mattress made in accordance with the present invention (Mattress 2D) had remarkably little fire damage when exposed to an open flame for 60 minutes (20 times as long). It is particularly remarkable that mattresses made in accordance with the present invention can pass the requirements of the California TB129 test even after being exposed to open flame for 60 minutes because current available products do not pass even after a 3 minute exposure unless the construction of the mattress is altered, sacrificing comfort.

Table III
California TB129 Summary of Results

| Test Specimen | | | Total Heat Released (MJ) | Weight Loss (lbs) | |
|---|---|---|---|---|---|
| California State | | Peak HRR (KW) | Less than 25 | Less than 3.0 | |
| Requirements | Mattress | Less than 100 | In the first 10 min | In the first 10 min | Status |
| #1 (Twin) | see below | 36.01 | 10.84 | 0.4 | passed |
| Extended Flame 60 min | | | | | |
| #2A (Twin) | see below | 30.09 | 9.09 | 0.4 | passed |
| #2B (Twin) | see below | 49.42 | 9.11 | 0.7 | passed |
| #2C (Twin) | see below | 23.76 | 3.03 | 0.4 | passed |
| #2D (Twin) | see below | 18.32 | 2.45 | 0.1 | passed |
| #2D (Twin) | see below | 56.69 | 10.74 | 0.3 | passed |
| Extended Flame 60 min | | | | | |
| #2E (Twin) | see below | 45.71 | 12.8 | 0.9 | passed |
| #2F (Twin) | see below | 30.31 | 6.95 | 0.1 | passed |
| #3 (Twin) Control | see below | 1585.52 | 129.79 | 6.1 | failed |
| #4 (Twin) | see below | 20.68 | 4.09 | 0.4 | passed |
| #5 (Twin) | see below | 56.71 | 12.96 | 2.4 | passed |
| #6 (Twin) | see below | 1027 | 10.86 | 2.3 | failed |
| #7 (Twin) | see below | 20.9 | 2.86 | 0.6 | passed |
| #8 (Twin) | see below | 23.3 | 5.4 | 0.4 | passed |
| #9 (Twin) | see below | 23.6 | 7.2 | 0.5 | passed |
| #10 (Twin) | see below | 22.02 | 5.2 | 0.5 | passed |
| #11 (Twin) | see below | 20.05 | 4.7 | 0.8 | passed |
| #12 (Twin) | see below | 24.7 | 18.0 | 2.2 | passed |

MATTRESS #1 (Twin)

| | |
|---|---|
| Quilt: | |
| Layer #1 | W.O. #23652 - Lineage |
| | Colibri * “C” White |
| | Warp 150d Flat Polyester |
| | Fill 6/1 Cotton |
| | Coated |
| | 64% Cotton, 36% Polyester |
| Layer #2 | Elk's Fire Barrier (Coated Glass Fabric) - |
| | Coated side facing layer #1 |
| Layer #3 | 2.0 oz Polyester Fiber |
| Layer #4 | 2.0 oz Polyester Fiber |
| Layer #5 | 0.25 inch Polyurethane Foam |
| Layer #6 | Elk's Fire Barrier (Coated Glass Fabric) - coated side |
| | facing layer #1 |
| Layer #7 | 0.0125 oz Non-Woven Sheet (Backing) |
| Other: | |
| Layer #8 | ⅝ inch Fibrous Pad |
| Layer #9 | 1.0 inch Fibrous Pad |
| Layer #10 | Spring |
| Border: | |
| Layer #1 | Same as above layer #1 (outer layer) |
| Layer #2 | Elk's Fire Barrier (Coated Glass Fabric) - coated side |
| | facing layer #1 |
| Layer #3 | 7/16 inch Polyurethane Foam |
| Layer #4 | Elk's Fire Barrier (coated Glass Fabric) - coated side |
| | facing layer #1 |
| Layer #5 | 0.50 oz Non-Woven sheet (backing) |
| Construction Material: | |
| | 1. Kevlar - Thread |
| | 2. Tape: ½ - 1.0″ (Flame Retarded) |

MATTRESS #2A (Twin)

| | |
|---|---|
| Quilt: | |
| Layer #1 | W.O. #23652 - Lineage |
| | Colibri * ‘C’ White |
| | Warp 150d Flat Polyester |
| | Fill 6/1 Cotton |
| | Coated |
| | 64% Cotton, 36% Polyester |
| Layer #2 | Elk's Fire Barrier (Coated Glass Fabric) - |
| | coated side facing layer #1 |
| Layer #3 | 2.0 oz Polyester Fiber |
| Layer #4 | 2.0 oz Polyester Fiber |
| Layer #5 | 0.25 inch Polyurethane Foam |
| Layer #6 | 0.0125 oz Non-Woven Sheet (Backing) |
| Other: | |
| Layer #7 | ⅝ inch Fibrous Pad |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | coated side facing layer #1 |
| Layer #3 | 7/16 inch Polyurethane Foam |
| Layer #4 | 0.50 oz Non-Woven sheet (backing) |
| Construction Material: | |
| | 1. Glass Thread - Flame Retarded |
| | 2. Tape: ½ - 1″ (Flame Retarded) |

MATTRESS #2B (Twin)

| | |
|---|---|
| Quilt: | |
| Layer #1 | W.O. #23105 - Nuance |
| | Braunfels* ‘C’ Talc |
| | Warp 30/2 Rayon |
| | Fill 300 d Polypropylene |
| | No Coating |
| | 74% Rayon, 26% Polypropylene |
| Layer #2 | Elk's Fire Barrier (Coated Glass Fabric) - |
| | coated side facing layer #1 |
| Layer #3 | 2.0 oz Polyester Fiber |
| Layer #4 | 2.0 oz Polyester Fiber |
| Layer #5 | 0.25 inch Polyurethane Foam |
| Layer #6 | 0.0125 oz Non-Woven Sheet (Backing) |
| Other: | |
| Layer #7 | ⅝ inch Fibrous Pad |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | coated side facing layer #1 |
| Layer #3 | 7/16 inch Polyurethane Foam |
| Layer #4 | 0.50 oz Non-Woven sheeting |
| Construction Material: | |
| | 1. Glass Thread - Flame Retarded |
| | 2. Tape: ½ - 1″ (Flame Retarded) |

MATTRESS #2C (Twin)

| | |
|---|---|
| Quilt: | |
| Layer #1 | W.O. #21710 - Palatial Jewel B |
| | Regency * White Honey |
| | Warp 150d Textured Polyester |
| | Fill 600d Polypropylene |
| | No Coating |
| | 58% Polypropylene, 42% Polyester |
| Layer #2 | Elk's Fire Barrier (Coated Glass Fabric) - |
| | coated side facing layer #1 |
| Layer #3 | 2.0 oz Polyester Fiber |
| Layer #4 | 2.0 oz Polyester Fiber |
| Layer #5 | ¼ inch Polyurethane Foam |
| Layer #6 | 0.0125 oz Non-Woven Sheet (Backing) |
| Other: | |
| Layer #7 | ⅝ inch Fibrous Pad |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.50 oz Non-Woven sheet (backing) |
| Construction Material: | |
| | 1. Glass Thread - Flame Retarded |
| | 2. Tape: ½ - 1″ (Flame Retarded) |

MATTRESS #2D (Twin)

| | |
|---|---|
| Quilt: | |
| Layer #1 | W.O. #21909 - Select |
| | Oakmont + * Vanilla White 2/150 |
| | Warp 150d Textured Polyester |
| | Fill 300d Textured Polyester |
| | Coated |
| | 100% Polyester |
| Layer #2 | Elk's Fire Barrier (Coated Glass Fabric) - |
| | coated side facing layer #1 |
| Layer #3 | 2.0 oz Polyester Fiber |
| Layer #4 | 2.0 oz Polyester Fiber |
| Layer #5 | 0.25 inch Polyurethane Foam |
| Layer #6 | 0.0125 oz Non-Woven Sheet (Backing) |
| Other: | |
| Layer #7 | ⅝ inch Fibrous Pad |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.50 oz Non-Woven sheet (backing) |
| Construction Material: | |
| | 1. Glass Thread - Flame Retarded |
| | 2. Tape: ½ - 1″ (Flame Retarded) |
| | 3. Silicone Spray |

MATTRESS #2E (Twin)

| | |
|---|---|
| Quilt: | |
| Layer #1 | W.O. #14557 - Classic |
| | Sea Life Blue |
| | Purchased knit |
| | Coated |
| | 100% Polyester |
| Layer #2 | Elk's Fire Barrier (Coated Glass Fabric) - |
| | coated side facing layer #1 |
| Layer #3 | 2.0 oz Polyester Fiber |
| Layer #4 | 2.0 oz Polyester Fiber |
| Layer #5 | 0.25 inch Polyurethane Foam |
| Layer #6 | 0.0125 oz Non-Woven Sheet (Backing) |
| Other: | |
| Layer #7 | ⅝ inch Fibrous Pad |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.050 oz Non-Woven sheet (backing) |
| Construction Material: | |
| | 1. Glass Thread - Flame Retarded |
| | 2. Tape: ½ - 1″ (Flame Retarded) |
| | 3. Silicone Spray |

MATTRESS #2F (Twin)

| | |
|---|---|
| Quilt: | |
| Layer #1 | W.O. #18655 - Lt. Wgt. Premier |
| | Juliet Plumdust |
| | Purchased Knit |
| | No Coating |
| | 100% Polyester |
| Layer #2 | Elk's Fire Barrier (Coated Glass Fabric) - |
| | coated side facing layer #1 |
| Layer #3 | 2.0 oz Polyester Fiber |
| Layer #4 | 2.0 oz Polyester Foam |
| Layer #5 | 0.25 inch Polyurethane Foam |
| Layer #6 | 0.0125 oz Non-Woven Sheet (Backing) |
| Other: | |
| Layer #7 | ⅝ inch Fibrous Pad |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.050 oz Non-Woven sheet (backing) |
| Construction Material: | |
| | 1. Glass Thread - Flame Retarded |
| | 2. Tape: ½ - 1″ (Flame Retarded) |
| | 3. Silicone Spray |

MATTRESS #3 (Twin)

| | |
|---|---|
| Quilt: | |
| Layer #1 | W.O. #21710 - Palatial Jewel B |
| | Regency * White Honey |
| | Warp 150d Textured Polyester |
| | Fill 600d Polypropylene |
| | No Coating |
| | 58% Polypropylene, 42% Polyester |
| Layer #2 | 2.0 oz Polyester Fiber |
| Layer #3 | 2.0 oz Polyester Fiber |
| Layer #4 | 0.25 inch Polyurethane Foam |
| Layer #5 | 0.125 Non-Woven Sheet |
| Other: | |
| Layer #6 | ⅝ inch Fibrous Pad |
| Layer #7 | 1.0 inch Fibrous Pad |
| Layer #8 | Spring |
| Border: | |
| Layer #1 | Same as above layer #1 (outer layer) |
| Layer #2 | 7/16 inch Polyurethane Foam |
| Layer #3 | 0.050 oz Non-Woven sheet (backing) |
| Construction Material: | |
| | 1. Conventional - Thread |
| | 2. Tape: ½ - 1″ (Conventional tape) |

MATTRESS #4 (Twin)

| | |
|---|---|
| Quilt: | |
| Layer #1 | W.O. #23652 - Lineage |
| | Colibri * “C” White |
| | Warp 150d Flat Polyester |
| | Fill 6/1 Cotton |
| | Coated |
| | 64% Cotton, 36% Polyester |
| Layer #2 | Elk's Fire Barrier (Coated Glass Fabric) - |
| | coated side facing layer #1 |
| Layer #3 | 2.0 oz Polyester Fiber |
| Layer #4 | 2.0 oz Polyester Fiber |
| Layer #5 | 0.25 inch Polyurethane Foam |
| Layer #6 | 0.0125 oz Non-Woven Sheet |
| Other: | |
| Layer #7 | ⅝ inch Fibrous Pad |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.050 oz Non-Woven sheet (Backing) |
| Construction Material: | |
| | 1. Kevlar - Thread |
| | 2. Tape: ½ - 1″ (Flame Retarded) |

MATTRESS #5 (Twin)

| | |
|---|---|
| Quilt: | |
| Layer #1 | W.O. #23105 - Nuance |
| | Braunfels * “C” Talc |
| | Warp 30/2 Rayon |
| | Fill 300d Polypropylene |
| | No Coating |
| | 74% Rayon, 26% Polypropylene |
| Layer #2 | Elk's Fire Barrier (Coated Glass Fabric) - |
| | coated side facing layer #1 |
| Layer #3 | ⅛ inch Polyurethane Foam |
| Layer #4 | 0.125 oz Non-Woven Sheet (Backing) |
| Layer #5 | ⅝ inch Fibrous pad |
| Layer #6 | 1.0 inch Fibrous pad |
| Other: | |
| Layer #7 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.050 oz Non-Woven sheet (backing) |
| Construction Material: | |
| | 1. Kevlar - Thread |
| | 2. Tape: ½ - 1″ (Flame Retarded) |

MATTRESS #6 (Twin)

| | |
|---|---|
| Quilt: | |
| Layer #1 | W.O. #23105 - Nuance |
| | Braunfels* “C” Talc |
| | Warp 30/2 Rayon |
| | Fill 300d Polypropylene |
| | No Coating |
| | 74% Rayon, 26% Polypropylene |
| Layer #2 | 2.0 oz Polyester Fiber |
| Layer #3 | Elk's Fire Barrier (Coated Glass fabric) - |
| | Coated side facing layer #1 |
| Layer #4 | 2.0 oz Polyester Fiber |
| Layer #5 | 0.25 inch Polyurethane Foam |
| Layer #6 | 0.0125 oz Non-Woven Sheet |
| Other: | |
| Layer #7 | ⅝ inch Fibrous Pad |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.50 oz Non-Woven sheet (backing) |
| Construction Material: | |
| | 1. Kevlar Thread |
| | 2. Tape: ½ - 1″ (Flame Retarded) |

MATTRESS #7 (Twin)

| | |
|---|---|
| Quilt: | |
| Layer #1 | Williamsburg Vanilla |
| | 96 Ends, 30 Picks |
| | Warp Polyester |
| | Fabric: 0.84 pounds per linear yard |
| | Fill: 6/1 Cotton |
| | Finish: Light clear coat |
| | 65% Cotton, 35% Polyester |
| Layer #2 | 1.5 oz Polyester Fiber |
| Layer #3 | Elk's Fire Barrier (Coated Glass fabric) |
| | Coated side facing layer #1 |
| Layer #4 | 2.0 oz Polyester Fiber |
| Layer #5 | 0.25 inch Polyurethane Foam |
| Layer #6 | 0.0125 oz Non-Woven Sheet |
| Other: | |
| Layer #7 | |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.50 oz Non-Woven sheet (backing) |
| Construction Material: | |
| | 1. Kevlar Thread |
| | 2. Tape: ½ - 1″ (Flame Retarded) |

MATTRESS #8 (Twin)

| | |
|---|---|
| Quilt: | |
| Layer #1 | Williamsburg Vanilla |
| | 96 Ends, 30 Picks |
| | Warp Polyester |
| | Fabric: 0.84 pounds per linear yard |
| | Fill: 6/1 Cotton |
| | Finish: Light clear coat |
| | 65% Cotton, 35% Polyester |
| Layer #2 | 1. oz Polyester Fiber |
| Layer #3 | Elk's Fire Barrier (Coated Glass fabric) |
| | Coated side facing layer #1 |
| Layer #4 | 2.0 oz Polyester Fiber |
| Layer #5 | 0.25 inch Polyurethane Foam |
| Layer #6 | 0.0125 oz Non-Woven Sheet |
| Other: | |
| Layer #7 | |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.50 oz Non-Woven sheet (backing) |
| Construction Material: | |
| | 1. Kevlar Thread |
| | 2. Tape: ½ - 1″ (Flame Retarded) |

MATTRESS #9 (Twin)

| | |
|---|---|
| Quilt: | |
| Layer #1 | Williamsburg Vanilla |
| | 96 Ends, 30 Picks |
| | Warp Polyester |
| | Fabric: 0.84 pounds per linear yard |
| | Fill: 6/1 Cotton |
| | Finish: Light clear coat |
| | 65% Cotton, 35% Polyester |
| Layer #2 | 0.75 oz Polyester Fiber |
| Layer #3 | Elk's Fire Barrier (Coated Glass fabric) |
| | Coated side facing layer #1 |
| Layer #4 | 2.0 oz Polyester Fiber |
| Layer #5 | 0.25 inch Polyurethane Foam |
| Layer #6 | 0.0125 oz Non-Woven Sheet |
| Other: | |
| Layer #7 | |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.50 oz Non-Woven sheet (backing) |
| Construction Material: | |
| | 1. Kevlar Thread |
| | 2. Tape: ½ - 1″ (Flame Retarded) |

MATTRESS #10 (Twin)

| | |
|---|---|
| Quilt: | |
| Layer #1 | Williamsburg Vanilla |
| | 96 Ends, 30 Picks |
| | Warp Polyester |
| | Fabric: 0.84 pounds per linear yard |
| | Fill: 6/1 Cotton |
| | Finish: Light clear coat |
| | 65% Cotton, 35% Polyester |
| Layer #2 | 0.75 oz Polyester Fiber |
| Layer #3 | Elk's Fire Barrier (Coated Glass fabric) |
| | Coated side facing layer #1 |
| Layer #4 | 2.0 oz Polyester Fiber |
| Layer #5 | 0.25 inch Polyurethane Foam |
| Layer #6 | 0.0125 oz Non-Woven Sheet |
| Other: | |
| Layer #7 | |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.50 oz Non-Woven sheet (backing) |
| Construction Material: | |
| | 1. Kevlar Thread |
| | 2. Tape: ½ - 1″ (Conventional) |

MATTRESS #11 (Twin)

| | |
|---|---|
| Quilt: | |
| Layer #1 | Williamsburg Vanilla |
| | 96 Ends, 30 Picks |
| | Warp Polyester |
| | Fabric: 0.84 pounds per linear yard |
| | Fill: 6/1 Cotton |
| | Finish: Light clear coat |
| | 65% Cotton, 35% Polyester |
| Layer #2 | 1.5 oz Polyester Fiber |
| Layer #3 | Elk's Fire Barrier (Coated Glass fabric) |
| | Coated side facing layer #1 |
| Layer #4 | 2.0 oz Polyester Fiber |
| Layer #5 | 0.25 inch Polyurethane Foam |
| Layer #6 | 0.0125 oz Non-Woven Sheet |
| Other: | |
| Layer #7 | |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.50 oz Non-Woven sheet (backing) |
| Construction Material: | |
| | 1. Conventional Thread |
| | 2. Tape: ½ - 1″ (Conventional) |

MATTRESS #12 (Twin)

| | |
|---|---|
| Quilt: | |
| Layer #1 | W.O. #23105 - Nuance |
| | Braunfels* “C” Talc |
| | Warp 30/2 Rayon |
| | Fill 300d Polypropylene |
| | No Coating |
| | 74% Rayon, 26% Polypropylene |
| Layer #2 | 0.25 inch Polyurethane Foam |
| Layer #3 | Elk's Fire Barrier (Coated Glass fabric) - |
| | Coated side facing layer #1 |
| Layer #4 | 2.0 oz Polyester Fiber |
| Layer #5 | 0.25 inch Polyurethane Foam |
| Layer #6 | 0.0125 oz Non-Woven Sheet |
| Other: | |
| Layer #7 | ⅝ inch Fibrous Pad |
| Layer #8 | 1.0 inch Fibrous Pad |
| Layer #9 | Spring |
| Border: | |
| Layer #1 | Same as above layer #1 (outer layer) |
| Layer #2 | Elk's Fire Barrier (Coated Glass Fabric) - |
| | Coated side facing layer #1 |
| Layer #3 | 7/16 inch Polyurethane Foam |
| Layer #4 | 0.50 oz Non-Woven sheet (backing) |
| Construction Material: | |
| | 1. Kevlar Thread |
| | 2. Tape: ½ - 1″ (Flame Retarded) |

It should be understood that the above examples are illustrative, and that compositions other than those described above can be used while utilizing the principles underlying the present invention. For example, other sources of filler as well as mixtures of acrylic latex and/or surfactants can be used in formulating the structural materials of the present invention. Moreover, the coating compositions can be applied to various types of substrates, as described above.

What is claimed is:

1. A structural material comprising a surfactant component, surfactant-generated microcells, a filler component and a binder component.

2. A fabric material comprising a substrate coated with a structural material comprising a surfactant component, surfactant-generated microcells, a filler component and a binder component.

3. The fabric material according to claim 2 wherein said substrate is planar and is coated on one side with said structural material.

4. The fabric material according to claim 2 wherein said substrate is planar and is coated on both sides with said structural material.

5. The fabric material according to claims 2, 3 or 4, wherein said fabric material further includes a water repellent material.

6. The fabric material according to claims 2, 3 or 4 wherein said fabric material further includes an antifungal material.

7. The fabric material according to claims 2, 3 or 4 wherein said fabric material further includes an antibacterial material.

8. The fabric material according to claims 2, 3 or 4 wherein said fabric material further includes a surface friction agent.

9. The fabric material according to claims 2, 3 or 4 wherein said fabric material further includes a flame retardant material.

10. The fabric material according to claims 2, 3 or 4 wherein said fabric material further includes an algaecide.

11. The fabric material according to claims 2, 3 or 4 wherein said fabric material is colored with dye.

12. A mattress fabric comprising a decorative fabric and a fabric material comprising a substrate coated with a structural material comprising a surfactant component, surfactant-generated microcells, a filler component and a binder component.

13. A mattress comprising a decorative fabric and a fabric material comprising a substrate coated with a structural material comprising a surfactant component, surfactant-generated microcells, a filler component and a binder component.

14. A mattress comprising
a) at least one first layer comprising a mattress fabric; and
b) at least one second layer adjacent to said first layer and comprising a fire resistant fabric material which comprises a substrate coated with a structural material comprising a surfactant component, surfactant-generated microcells, a filler component and a binder component.

15. The mattress according to claim 14 wherein the at least one first layer comprises fibers selected from the group consisting essentially of cotton, polyester, rayon, polypropylene, and combinations thereof.

16. The mattress according to claim 14 wherein the at least one first layer is ticking.

17. The mattress according to claim 14 further comprising
(a) a third layer adjacent to the second layer,
(b) a fourth layer adjacent to the third layer, wherein each of said third and fourth layers comprises a cushion layer, and
(c) a fifth layer adjacent to the fourth layer and comprising polyurethane foam.

18. The mattress according to claim 17 further comprising
(a) a sixth layer adjacent to the fifth layer and comprising a fire resistant fabric material; and
(b) a seventh layer adjacent to the sixth layer and comprising a non-woven sheet.

19. The mattress according to claim 17 further comprising a sixth layer adjacent to the fifth layer and comprising a non-woven sheet.

20. The mattress according to claim 14 further comprising a border which comprises
a) a first layer comprising a mattress fabric; and
b) a second layer adjacent to the first layer and comprising a fire resistant fabric material which comprises a substrate coated with a structural material comprising a surfactant component, surfactant-generated microcells, a filler component and a binder component.

21. The mattress according to claim 20 wherein said border further comprises a third layer adjacent to the second layer and comprising a polyurethane foam.

22. The mattress according to claim 21 wherein said border further comprises a fourth layer adjacent to the third layer and comprising a non-woven sheet.

23. The mattress according to claim 21 wherein said border further comprises
(a) a fourth layer adjacent to the third layer and comprising a fire resistant fabric material; and
(b) a fifth layer adjacent to the fourth layer and comprising a non-woven sheet.

24. The mattress according to claim 14 further comprising
a) at least one third layer adjacent to the at least one second layer and comprising a polyurethane foam;
b) at least one fourth layer adjacent to the third layer and comprising a non-woven sheet;
c) at least one fifth layer adjacent to the fourth layer and comprising a fibrous pad; and
d) at least one sixth layer adjacent to the fifth layer and comprising a fibrous pad.

25. A mattress comprising
a) at least one first layer comprising a mattress fabric;
b) at least one second layer adjacent to the first layer and wherein the second layer is a cushion layer; and
c) at least one third layer adjacent to the second layer and comprising a fire resistant fabric material which comprises a substrate coated with a structural material comprising a surfactant component, surfactant-generated microcells, a filler component and a binder component.

26. The mattress according to claim 25 further comprising
a) at least one fourth layer adjacent to the third layer wherein said fourth layer comprises a cushion layer;
b) at least one fifth layer adjacent to the fourth layer, wherein said fifth layer comprises a polyurethane foam; and
c) at least one sixth layer adjacent to the fifth layer wherein said sixth layer comprises a non-woven sheet.

27. The mattress according to claims 14, 15, 16, 17, 18, 19, 20, 21, 22, 23, 24, 25, or 26 further comprising a layer which comprises springs.

28. The mattress according to claims 17 or 26 wherein the cushion layer is selected from the group consisting of polyester fibers and polyurethane foam.
